(19) United States
(12) Patent Application Publication
(10) Pub. No.: US 2014/0210934 A1
(43) Pub. Date: Jul. 31, 2014

(54) RIBBON WEB GUIDE AND METHOD FOR A RIBBON PRINTING SYSTEM

(71) Applicant: ILLINOIS TOOL WORKS INC., GLENVIEW, IL (US)

(72) Inventor: Indarjit Deonarine, Schaumburg, IL (US)

(73) Assignee: Illinois Tool Works Inc., GLENVIEW, IL (US)

(21) Appl. No.: 13/755,961

(22) Filed: Jan. 31, 2013

(51) Int. Cl. B41J 33/14

(52) U.S. Cl. CPC B41J 33/14
USPC 347/214; 400/248

(57) ABSTRACT

A ribbon guide for a ribbon printing system includes a body that is elongated along a longitudinal axis from a base end an opposite end and having a tapered shape from the base end to the opposite end. The body is configured to be coupled with a cassette plate of the ribbon printing system along a path taken by a print ribbon in the ribbon printing system such that the body deflects the print ribbon to travel away from the cassette plate when the print ribbon is pulled from an unwind spindle to a windup spindle in the ribbon printing system.

### BACKGROUND

A variety of printing systems can apply or print images (e.g., graphics, text, or the like) on exterior surfaces of objects. Many of these systems directly engage or contact the exterior surfaces on which the images are printed. For example, a thermal transfer printing process can involve a print ribbon having ink that is transferred onto a target object by applying heat and pressure to the print ribbon as the print ribbon engages the target object. This print ribbon also may be referred to as a web or ribbon web. The print ribbon may be provided from an unwind spindle or reel, where the print ribbon extends through one or more rollers to cause the ribbon to be disposed between a thermal print head and the target object. From this location, the print ribbon may extend through one or more rollers to a windup spindle or reel. The second spindle may apply a torque to cause the print ribbon to unwind from the first spindle and move between the thermal print head and the target object, as well as move relative to the thermal print head and the target object, as the thermal print head applies heat and pressure to transfer ink from the print ribbon onto the target object.

### BRIEF SUMMARY

In one embodiment, a ribbon guide for a ribbon printing system includes a body that is elongated along a longitudinal axis from a base end an opposite end and having a tapered shape from the base end to the opposite end. The body is configured to be coupled with a cassette plate of the ribbon printing system along a path taken by a print ribbon in the ribbon printing system such that the body deflects the print ribbon to travel away from the cassette plate when the print ribbon is pulled from an unwind spindle to a windup spindle in the ribbon printing system.

In one embodiment, a ribbon printing system includes an unwind spindle, a windup spindle, one or more rollers, and a ribbon guide. The unwind spindle is operably connected with a cassette plate and includes a length of print ribbon wound thereon. The windup spindle is operably connected with the cassette plate and is configured to be coupled with the print ribbon such that the windup spindle pulls the print ribbon from the unwind spindle. The one or more rollers are arranged to direct the print ribbon through a printing area as the print ribbon at least partially passes over the one or more rollers. A thermal print head engages the print ribbon in the printing area to transfer ink from the print ribbon onto one or more target objects. The ribbon guide is operably connected with the cassette plate and configured to deflect the print ribbon away from the cassette plate when the print ribbon is pulled across the ribbon guide by the windup spindle.

In one embodiment, a method includes pulling a length of print ribbon from an unwind spindle operably connected with a cassette plate of a ribbon printing system, pulling the print ribbon across one or more rollers to direct the print ribbon through a printing area, engaging the print ribbon with a thermal print head to transfer ink from the print ribbon onto one or more target objects as the ribbon passes through the printing area, deflecting the print ribbon away from the cassette plate when the print ribbon is pulled across a ribbon guide by the windup spindle, and collecting the print ribbon onto the windup spindle.

### BRIEF DESCRIPTION OF THE DRAWINGS

Reference is now made briefly to the accompanying drawings, in which:

FIG. 1 is a schematic view of one embodiment of a printing system;

FIG. 2 is a side view of the printing system shown in FIG. 1;

FIG. 3 is a schematic view of a printing system in accordance with an embodiment of the inventive subject matter;

FIG. 4 illustrates a perspective view of one embodiment of the ribbon guide;

FIG. 5 illustrates a side view of the printing system shown in FIG. 3; and

FIG. 6 is a flowchart of a method for guiding a print ribbon in a printing system.

### DETAILED DESCRIPTION

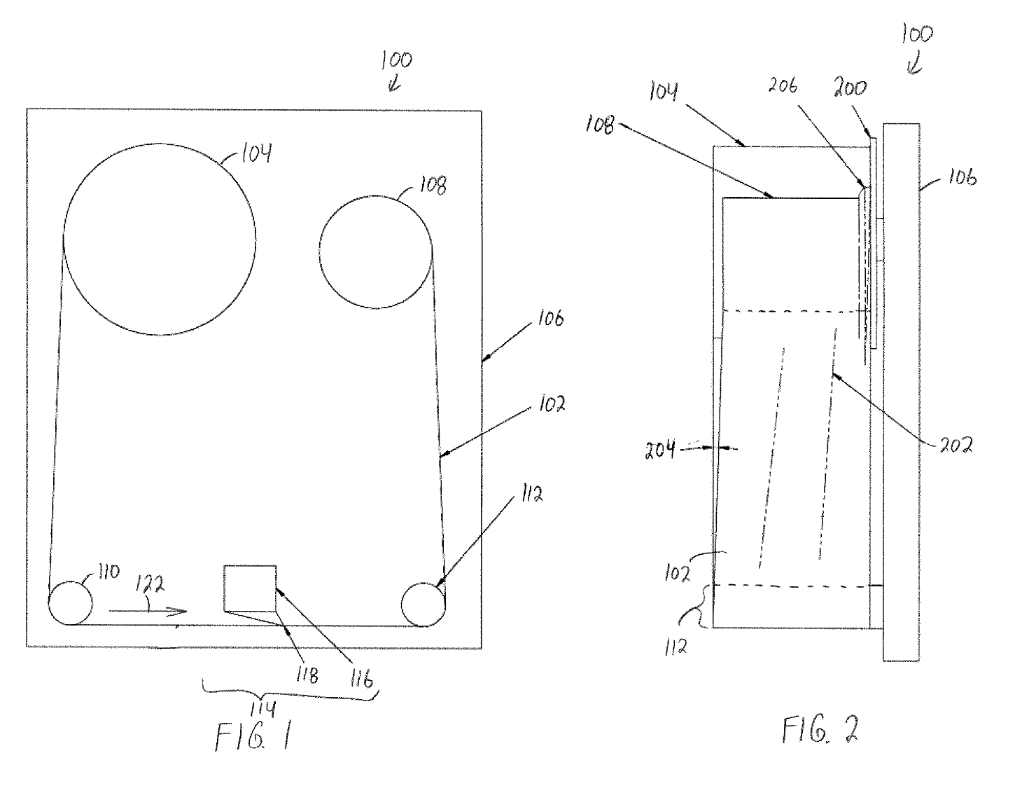

FIG. 1 is a schematic view of one embodiment of a printing system 100. The printing system 100 may be a thermal printing system that prints images on exterior surfaces of target objects by applying heat and pressure to a print ribbon 102 that includes ink. This heat and pressure transfers the ink from the print ribbon 102 onto the target objects. The print ribbon 102 is provided from an unwind spindle or reel 104 that is rotatably mounted on a cassette plate 106 (e.g., the unwind spindle 104 can rotate relative to the cassette plate 106). The ribbon 102 may be pulled from the unwind spindle 104 by a windup spindle 108 that pulls the ribbon 102 through the system 100. For example, the windup spindle 108 may pull the ribbon 102 across rollers 110, 112 and through a printing zone 114 in the direction represented by arrow 122. A thermal printhead 116 applies heat and pressure to the ribbon 102 via a blade 118 to transfer ink in the ribbon 102 to a target object.

FIG. 2 is a side view of the printing system 100 shown in FIG. 1. The windup spindle 108 may include or be coupled with a flange 200 that outwardly protrudes from the windup spindle 108. As the print ribbon 102 is transferred from the unwind reel 104 to the windup reel 108, the ribbon web 102 is pressed onto the target object by the print blade 118 of the thermal printhead 116. The pressure applied to the ribbon 102 is transverse to the direction of travel (e.g., arrow 122) of the ribbon web 102. During a printing cycle that lasts a relatively short time period (e.g., only for milliseconds), this transverse printhead pressure can cause the ribbon web 102 to veer off course. In some cases, depending on the distribution of this transverse pressure, the ribbon 102 veers toward the cassette plate 106 that holds the windup and unwind reels 108, 104. For example, the web 102 may move along a path that is angled downward by an angle 204 relative to the portion of the web 102 coming off of the unwind spindle 104. This angle 204 of travel can cause a portion of the web 102 to bunch up against the flange 200 and form curling 206 on the windup spindle 108. The web 102 can cause reflected wrinkling 202 from the windup reel 108 to the printing zone 114, and even further upstream of the thermal printhead 116 toward the unwind spindle 104. Wrinkling in the printing zone 114 can result in longitudinal, diagonal, or random linear streaks where printing is missing. The resulting images may be useless, especially when printing barcodes, matrix codes, and such like.

FIG. 3 is a schematic view of a printing system 300 in accordance with an embodiment of the inventive subject matter. Similar to the printing system 100, the printing system 300 may be a thermal printing system that prints images on exterior surfaces of target objects by applying heat and pressure to a print ribbon 302 that includes ink. The system 300 includes an unwind spindle or reel 304 that is rotatably mounted on a cassette plate 306. The ribbon 302 may be pulled from the unwind spindle 304 by a windup spindle 308 that pulls the ribbon 302 through the system 300. For example, the windup spindle 308 may pull the ribbon 302 across rollers 310, 312 and through a printing zone 314 in the direction represented by arrow 322. A thermal printhead 316 applies heat and pressure to the ribbon 302 via a blade 318 to transfer ink in the ribbon 302 to a target object.

In order to prevent the ribbon 302 from bunching up and forming wrinkles 202 (shown in FIG. 2), a ribbon guide 324 is placed into contact with the ribbon 302 along the path traversed by the ribbon 302 from the unwind spindle 304 to the windup spindle 308. The ribbon guide 324 alters the orientation and/or path of the ribbon 302 relative to other components in the system 300. The ribbon guide 324 may be a stationary body or a body that rotates as the ribbon 302 engages and passes over the ribbon guide 324 to be pulled onto the windup spindle 308.

Upstream of the ribbon guide 324 along the direction of travel of the ribbon 302, the ribbon 302 may be oriented perpendicular to the plane of the cassette plate 306, as shown in FIG. 3. As the ribbon 302 passes over the ribbon guide 324, the ribbon 302 becomes obliquely angled with respect to the cassette plate 306 in areas 326, 328 that are upstream and downstream of the ribbon guide 324, respectively. As shown in FIG. 3, the ribbon guide 324 may be positioned such that the ribbon 302 is at least partially deflected and the path traveled by the ribbon 302 from the roller 312 to the windup spindle 308 is longer than the path traveled by the ribbon 102 from the roller 112 to the windup spindle 108, as shown in FIG. 1.

With continued reference to the printing system 300 shown in FIG. 3, FIG. 4 illustrates a perspective view of one embodiment of the ribbon guide 324. The ribbon guide 324 is a tapered body that is elongated along a longitudinal axis 406 from an upper end 400 to an opposite base end 402. For example, the ribbon guide 324 is longer between the ends 400, 402 than between other outer surfaces in other directions. The guide 324 may have a frustoconical shape, such as the shape of a frustum of a cone or a pyramid (where the cone or pyramid having a tip truncated or removed at a plane parallel to the base of the cone or pyramid). The ribbon guide 324 has a tapered shape such that an outer diameter or width dimension 404 at the upper end 400 is smaller than the outer diameter or width dimension 404 at the lower end 402, with the outer diameters or width dimensions gradually increasing from the upper end 400 to the lower end 402 at different locations along the length of the ribbon guide 324 from the upper end 400 to the lower end 402. Alternatively, the ribbon guide 324 may have another shape. For example, the ribbon guide 324 may have one or more different curves, diameters, straight sections (having the same outer diameters or width dimensions), or the like.

The ribbon guide 324 may be mounted onto the cassette plate 306 such that the longitudinal axis 324 of the ribbon guide 324 is perpendicular to the cassette plate 306. Alternatively, the ribbon guide 324 may be mounted onto the cassette plate 306 such that the longitudinal axis 324 is obliquely oriented with respect to a plane defined by the upper surface of the cassette plate 306 (e.g., the surface that is visible in FIG. 3). The ribbon guide 324 may be stationary such that the ribbon guide 324 does not rotate relative to the cassette plate 306. Alternatively, the ribbon guide 324 may rotate relative to the cassette plate 306.

As the ribbon 302 passes over the ribbon guide 324, the larger diameter of the guide 324 makes tangential contact with the inside edge of the ribbon web 302 and the smaller diameter of the guide 324 makes tangential contact with the outside edge of the ribbon web 302. For example, the portions of the guide 324 that are closer to the lower end 324 than the upper end 400 engage the portions of the ribbon web 302 that are located closer to the edge of the ribbon 302 that faces the cassette plate 306. The portions of the guide 324 that are closer to the upper end 400 engage the portions of the ribbon web 302 that are located closer to the opposite edge of the ribbon 302, such as the edge that faces away from the cassette plate 306.

The guide 324 subjects the ribbon 302 to a transverse linear varying tension that is larger along the edge of the ribbon 302 that faces the cassette plate 306. As the ribbon 302 moves over the guide 324, the ribbon 302 is guided toward the upper end 400 of the guide 324 where tension in the ribbon 302 is lower. After some wraps of the ribbon 302 on the windup spindle 308, the ribbon 302 is collected onto the windup spindle 308 with a relatively constant gap between the windup spindle 308 and the cassette plate 306.

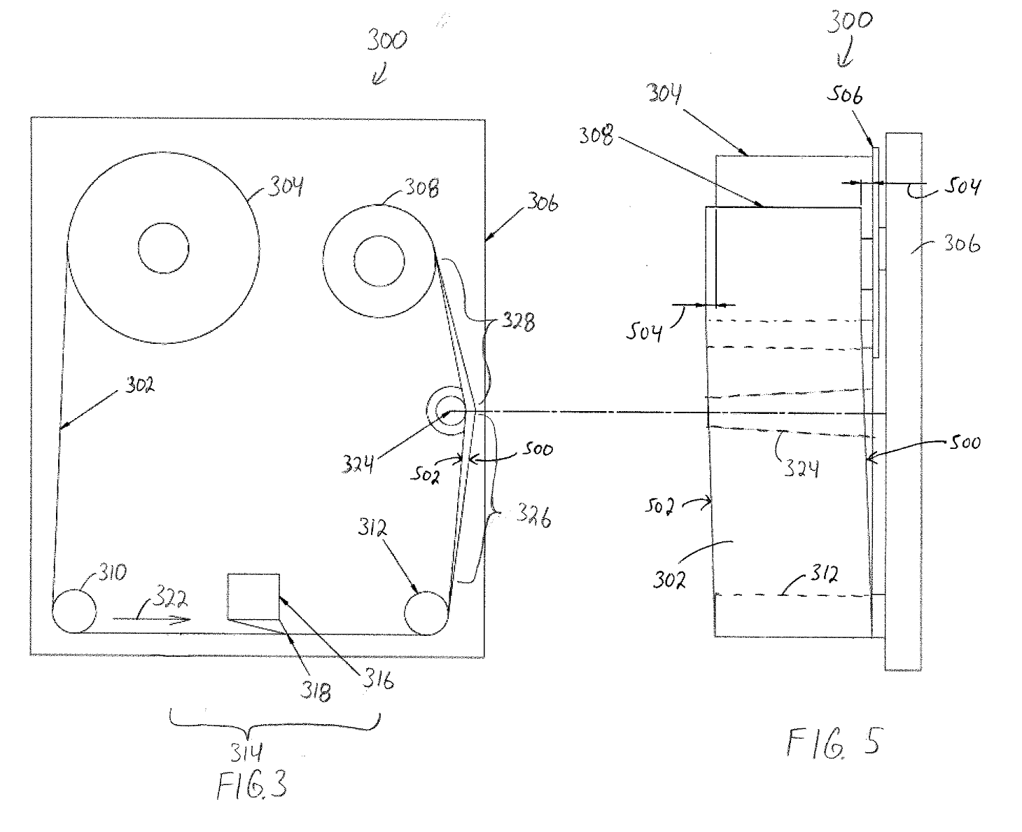

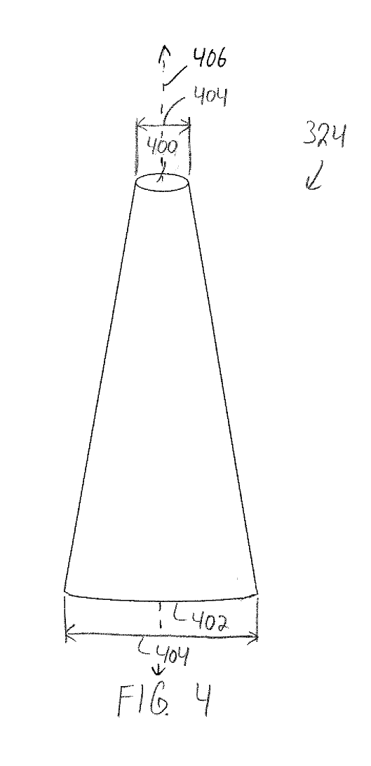

FIG. 5 illustrates a side view of the printing system 300 shown in FIG. 3. The ribbon 302 laterally extends between opposite edges 500, 502, with the edge 500 facing the cassette plate 306 and the opposite edge 502 facing away from the cassette plate 306. As described above, passage of the ribbon 302 over the guide 324 causes the ribbon 302 to become obliquely (e.g., non-perpendicularly) angled with respect to the cassette plate 306 over at least a portion of the path traversed by the ribbon 302 that leads up to the windup spindle 308. For example, with respect to the top view shown in FIG. 3, prior to the ribbon 302 passing the roller 312, the ribbon 302 is oriented substantially perpendicular or perpendicular to the cassette plate 306 (e.g., such that only the edge 502 is visible in FIG. 3). Upon passing the roller 312, however, the ribbon 302 begins to slightly rotate due to later passage of the ribbon 302 over the guide 324. This rotation results in the ribbon 302 being oriented at an oblique angle with respect to the cassette plate 306 such that both the edges 500 and 502 are at least partially visible in FIG. 3.

The passage of the ribbon 302 over the guide 324 also moves the ribbon 302 away from the cassette plate 306. As shown in FIG. 5, the ribbon 302 is urged away from the cassette plate 306 due to the lower tension in the ribbon 302 in locations of the ribbon 302 that are closer to the edge 502 and the greater tension in the ribbon 302 in locations of the ribbon 302 that are closer to the edge 500. The distance at which the ribbon 302 is urged and moved away from the cassette plate 306 relative to the location of the ribbon 302 on the unwind spindle 304 is referred to as a displacement distance 504. The guide 324 directs the ribbon 302 away from the cassette plate 306 by the displacement distance 504 that is sufficiently large to prevent the ribbon 302 from engaging and/or bunching up against a flange 506 of the windup spindle 308. The unwind and windup spindles 304, 308 may be located the same distance or substantially the same distance from the cassette plate 306, with the guide 324 causing the ribbon 302 to move away from the flange 506 of the windup spindle 308 without the guide 324 being actuated or otherwise moving away from the cassette plate 306. While the printing system 300 is shown as including only a single guide 324, in another embodiment, the printing system 300 may include two or more guides 324 to further increase the displacement distance 504.

By guiding the ribbon 302 away from the flange 506 of the windup spindle 308, the guide 324 can assist in preventing the ribbon 302 from bunching up against the flange 506. Avoiding this bunching of the ribbon 302 also can prevent the formation of wrinkles in the ribbon 302, which can prevent the propagation of such wrinkles through the ribbon 302 and into the printing area 314. Preventing the introduction of wrinkles into the printing area 314 can improve printing on the target objects from the ribbon 302, as described above.

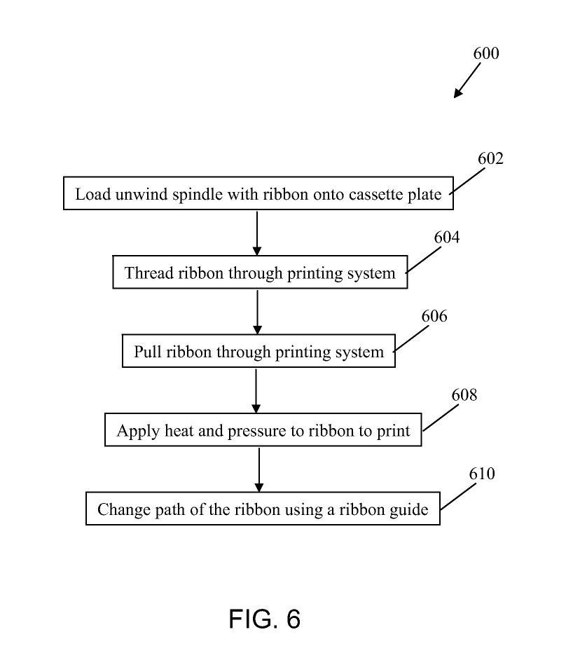

FIG. 6 is a flowchart of a method 600 for guiding a print ribbon in a printing system. The method 600 may be used in conjunction with the printing system 300 and the guide 324 shown in FIG. 3. At 602, the unwind spindle 304 is loaded onto the cassette plate 306. At 604, the ribbon 302 on the unwind spindle 304 is threaded through the printing system 300, such as by manually passing the ribbon 302 from the unwind spindle 302, at least partially across one or more rollers 310, 312, through the printing area 314, and at least partially across the guide 324. The ribbon 302 can be connected with the windup spindle 308.

At 606, the windup spindle 308 pulls the ribbon 302 through the printing system 300. For example, the windup spindle 308 may pull the ribbon 302 across the one or more rollers 310, 312, through the printing area 314, and over the guide 324. At 608, the print head 302 can apply heat and pressure to the ribbon 302 in the printing area 314 as the windup spindle 308 pulls the ribbon 302 through the printing system 300 in order to print images onto one or more target objects.

At 610, as the windup spindle 308 is pulling the ribbon 302 through the printing system 300 and/or as the print head 302 engages the ribbon 302 to form images on the one or more target objects, the guide 324 changes the path taken by the ribbon 302 to prevent wrinkles from forming in the ribbon 302. As described above, the guide 324 may direct the ribbon 302 away from the flange 506 of the windup spindle 308 so that the ribbon 302 does not bunch up against the flange 506 and form wrinkles The method 600 may continue until printing on the one or more target objects is complete and/or the ribbon 302 is fully consumed from the unwind spindle 302.

In one embodiment, a ribbon guide for a ribbon printing system includes a body that is elongated along a longitudinal axis from a base end an opposite end and having a tapered shape from the base end to the opposite end. The body is configured to be coupled with a cassette plate of the ribbon printing system along a path taken by a print ribbon in the ribbon printing system such that the body deflects the print ribbon to travel away from the cassette plate when the print ribbon is pulled from an unwind spindle to a windup spindle in the ribbon printing system.

In one aspect, the body deflects the print ribbon away from the cassette plate to prevent the print ribbon from bunching up on the windup spindle and forming wrinkles in the print ribbon.

In one aspect, the windup spindle includes an outwardly protruding flange and the body deflects the print ribbon away from the flange as the print ribbon is wound up onto the windup spindle.

In one aspect, the body has a frustoconical shape.

In one aspect, the tapered shape of the body has a larger width dimension at the base end and a smaller width dimension at the opposite end.

In one aspect, the base end of the body faces the cassette plate.

In one aspect, the print ribbon has a width dimension that extends from a first edge that faces the cassette plate to an opposite second edge that faces away from the cassette plate. The body deflects the print ribbon away from the cassette plate altering tension across the width dimension of the print ribbon.

In one aspect, the body alters the tension across the width dimension of the print ribbon by decreasing the tension in one or more portions of the print ribbon that are disposed closer to the second edge than the first edge of the print ribbon relative to the tension in one or more other portions of the print ribbon that are disposed closer to the first edge than the second edge of the print ribbon.

In one aspect, the print ribbon is pulled from the unwind spindle such that the print ribbon is oriented perpendicular to a surface of the cassette plate that faces the print ribbon. The body deflects the print ribbon such that the print ribbon is obliquely angled with respect to the surface of the cassette plate.

In one embodiment, a ribbon printing system includes an unwind spindle, a windup spindle, one or more rollers, and a ribbon guide. The unwind spindle is operably connected with a cassette plate and includes a length of print ribbon wound thereon. The windup spindle is operably connected with the cassette plate and is configured to be coupled with the print ribbon such that the windup spindle pulls the print ribbon from the unwind spindle. The one or more rollers are arranged to direct the print ribbon through a printing area as the print ribbon at least partially passes over the one or more rollers. A thermal print head engages the print ribbon in the printing area to transfer ink from the print ribbon onto one or more target objects. The ribbon guide is operably connected with the cassette plate and configured to deflect the print ribbon away from the cassette plate when the print ribbon is pulled across the ribbon guide by the windup spindle.

In one aspect, the ribbon guide is positioned to deflect portions of the print ribbon away from the cassette plate subsequent to the portions of the print ribbon passing through the printing area and prior to the portions of the print ribbon being received on the windup spindle.

In one aspect, the ribbon guide is elongated along a longitudinal axis from a base end an opposite end and having a tapered shape from the base end to the opposite end.

In one aspect, the ribbon guide deflects the print ribbon away from the cassette plate to prevent the print ribbon from bunching up on the windup spindle and forming wrinkles in the print ribbon.

In one aspect, the windup spindle includes an outwardly protruding flange, and the ribbon guide deflects the print ribbon away from the flange as the print ribbon is wound up onto the windup spindle.

In one aspect, the ribbon guide has a frustoconical shape.

In one aspect, the ribbon guide has a larger width dimension at a base end and a smaller width dimension at an opposite end.

In one aspect, the base end of the ribbon guide faces the cassette plate.

In one aspect, the print ribbon has a width dimension that extends from a first edge that faces the cassette plate to an opposite second edge that faces away from the cassette plate. The ribbon guide deflects the print ribbon away from the cassette plate by altering tension across the width dimension of the print ribbon.

In one aspect, the ribbon guide alters the tension across the width dimension of the print ribbon by decreasing the tension in one or more portions of the print ribbon that are disposed closer to the second edge than the first edge of the print ribbon relative to the tension in one or more other portions of the print ribbon that are disposed closer to the first edge than the second edge of the print ribbon.

In one embodiment, a method includes pulling a length of print ribbon from an unwind spindle operably connected with a cassette plate of a ribbon printing system, pulling the print ribbon across one or more rollers to direct the print ribbon through a printing area, engaging the print ribbon with a thermal print head to transfer ink from the print ribbon onto one or more target objects as the ribbon passes through the printing area, deflecting the print ribbon away from the cassette plate when the print ribbon is pulled across a ribbon guide by the windup spindle, and collecting the print ribbon onto the windup spindle.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

1. A ribbon guide for a ribbon printing system, the ribbon guide comprising:
a body that is elongated along a longitudinal axis from a base end an opposite end and having a tapered shape from the base end to the opposite end,
wherein the body is configured to be coupled with a cassette plate of the ribbon printing system along a path taken by a print ribbon in the ribbon printing system such that the body deflects the print ribbon to travel away from the cassette plate when the print ribbon is pulled from an unwind spindle to a windup spindle in the ribbon printing system.

2. The ribbon guide of claim 1, wherein the body deflects the print ribbon away from the cassette plate to prevent the print ribbon from bunching up on the windup spindle and forming wrinkles in the print ribbon.

3. The ribbon guide of claim 1, wherein the windup spindle includes an outwardly protruding flange, and the body deflects the print ribbon away from the flange as the print ribbon is wound up onto the windup spindle.

4. The ribbon guide of claim 1, wherein the body has a frustoconical shape.

5. The ribbon guide of claim 1, wherein the tapered shape of the body has a larger width dimension at the base end and a smaller width dimension at the opposite end.

6. The ribbon guide of claim 5, wherein the base end of the body faces the cassette plate.

7. The ribbon guide of claim 1, wherein the print ribbon has a width dimension that extends from a first edge that faces the cassette plate to an opposite second edge that faces away from the cassette plate, the body deflecting the print ribbon to travel away from the cassette plate altering tension across the width dimension of the print ribbon.

8. The ribbon guide of claim 7, wherein the body alters the tension across the width dimension of the print ribbon by decreasing the tension in one or more portions of the print ribbon that are disposed closer to the second edge than the first edge of the print ribbon relative to the tension in one or more other portions of the print ribbon that are disposed closer to the first edge than the second edge of the print ribbon.

9. The ribbon guide of claim 1, wherein the print ribbon is pulled from the unwind spindle such that the print ribbon is oriented perpendicular to a surface of the cassette plate that faces the print ribbon, and the body deflects the print ribbon such that the print ribbon is obliquely angled with respect to the surface of the cassette plate.

10. A ribbon printing system comprising:
an unwind spindle operably connected with a cassette plate, the unwind spindle including a length of print ribbon wound thereon;
a windup spindle operably connected with the cassette plate and configured to be coupled with the print ribbon such that the windup spindle pulls the print ribbon from the unwind spindle;
one or more rollers arranged to direct the print ribbon through a printing area as the print ribbon at least partially passes over the one or more rollers, wherein a thermal print head engages the print ribbon in the printing area to transfer ink from the print ribbon onto one or more target objects; and
a ribbon guide operably connected with the cassette plate and configured to deflect the print ribbon away from the cassette plate when the print ribbon is pulled across the ribbon guide by the windup spindle.

11. The ribbon printing system of claim 10, wherein the ribbon guide is positioned to deflect portions of the print ribbon away from the cassette plate subsequent to the portions of the print ribbon passing through the printing area and prior to the portions of the print ribbon being received on the windup spindle.

12. The ribbon printing system of claim 10, wherein the ribbon guide is elongated along a longitudinal axis from a base end an opposite end and having a tapered shape from the base end to the opposite end.

13. The ribbon printing system of claim 10, wherein the ribbon guide deflects the print ribbon away from the cassette plate to prevent the print ribbon from bunching up on the windup spindle and forming wrinkles in the print ribbon.

14. The ribbon printing system of claim 10, wherein the windup spindle includes an outwardly protruding flange, and the ribbon guide deflects the print ribbon away from the flange as the print ribbon is wound up onto the windup spindle.

15. The ribbon printing system of claim 10, wherein the ribbon guide has a frustoconical shape.

16. The ribbon printing system of claim 10, wherein the ribbon guide has a larger width dimension at a base end and a smaller width dimension at an opposite end.

17. The ribbon printing system of claim 16, wherein the base end of the ribbon guide faces the cassette plate.

18. The ribbon printing system of claim 10, wherein the print ribbon has a width dimension that extends from a first edge that faces the cassette plate to an opposite second edge that faces away from the cassette plate, and the ribbon guide deflects the print ribbon away from the cassette plate by altering tension across the width dimension of the print ribbon.

19. The ribbon printing system of claim 18, wherein the ribbon guide alters the tension across the width dimension of the print ribbon by decreasing the tension in one or more portions of the print ribbon that are disposed closer to the second edge than the first edge of the print ribbon relative to the tension in one or more other portions of the print ribbon that are disposed closer to the first edge than the second edge of the print ribbon.

20. A method comprising:
pulling a length of print ribbon from an unwind spindle operably connected with a cassette plate of a ribbon printing system;
pulling the print ribbon across one or more rollers to direct the print ribbon through a printing area;
engaging the print ribbon with a thermal print head to transfer ink from the print ribbon onto one or more target objects as the ribbon passes through the printing area;
deflecting the print ribbon away from the cassette plate when the print ribbon is pulled across a ribbon guide by the windup spindle; and
collecting the print ribbon onto the windup spindle.
